(19) United States
(12) Patent Application Publication
(10) Pub. No.: US 2025/0374376 A1
(43) Pub. Date: Dec. 4, 2025

(54) PORTABLE HAND WARMER HAVING MAGNETIC ATTRACTION FUNCTION

(71) Applicant: Dongguan Hongyutai Electronics Co., Ltd, Dongguan (CN)

(72) Inventors: Huashan Liu, Dongguan (CN); Juju Deng, Dongguan (CN)

(21) Appl. No.: 18/814,666

(22) Filed: Aug. 26, 2024

(30) Foreign Application Priority Data
May 29, 2024 (CN) 202421197544.7

(51) Int. Cl. H05B 3/06

(52) U.S. Cl. CPC H05B 3/06

(57) ABSTRACT

The present invention discloses a portable hand warmer having a magnetic attraction function, comprising two sets of face shells and two sets of bottom shells, the face shells being mounted on the bottom shells, wherein heating sheets are mounted on the face shells, arc-shaped heat-conducting hardware shells are mounted on the heating sheets, and the arc-shaped heat-conducting hardware shells are connected to the face shells; top portions and bottom portions of inner walls of the bottom shells are provided with magnet positioning cavities, and magnets are mounted inside the magnet positioning cavities; and batteries are mounted at middle ends of inner cavities of the bottom shells, PCBA boards are mounted at head portions of the inner cavities of the bottom shells, and the PCBA boards are electrically connected to the batteries and the heating sheets. The present invention has the advantage of being convenient to use.

### CROSS-REFERENCE TO RELATED APPLICATIONS

This is a U.S. patent application which claims the priority and benefit of Chinese Patent Application Number 202421197544. 7, filed on May 29, 2024, the disclosure of which is incorporated herein by reference in its entirety.

### TECHNICAL FIELD

The present invention relates to the technical field of electronic products, specifically to a portable hand warmer having a magnetic attraction function.

### BACKGROUND

Portable hand warmers belong to a type of small electronic products, which are suitable for providing warmth to hands in cold weather. They utilize electrothermal conversion and are equipped with a charging function, enabling them to be connected, by means of charging interfaces, to power sources for charging. Such a hand warmer is small, portable and compact in design, can be easily held in a hand or put into a pocket or bag, and does not increase the burden of carrying. Moreover, power is supplied by a battery built in the hand warmer, and by pressing a switch button, the hand warmer can quickly emit heat to provide instant warmth to a user.

Existing portable hand warmers having a magnetic function have low heat energy transfer efficiency during use, which reduces the convenience of use of the hand warmers, and it is difficult to disassemble heat-conducting elements, which increases the difficulty of cleaning and maintenance.

### SUMMARY

The object of the present invention is to provide a portable hand warmer having a magnetic attraction function, which has the advantage of being convenient to use, and solves the problems that existing portable hand warmers having a magnetic function have low heat energy transfer efficiency during use, which reduces the convenience of use of the hand warmers, and it is difficult to disassemble heat-conducting elements, which increases the difficulty of cleaning and maintenance.

In order to achieve the above object, the present invention provides the following technical solution: a portable hand warmer having a magnetic attraction function, comprising two sets of face shells and two sets of bottom shells, the face shells being mounted on the bottom shells.

Heating sheets are mounted on the face shells. Arc-shaped heat-conducting hardware shells are mounted on the heating sheets. The arc-shaped heat-conducting hardware shells are connected to the face shells.

Top portions and bottom portions of inner walls of the bottom shells are provided with magnet positioning cavities. Magnets are mounted inside the magnet positioning cavities.

Batteries are mounted at middle ends of inner cavities of the bottom shells. PCBA boards are mounted at head portions of the inner cavities of the bottom shells. The PCBA boards are electrically connected to the batteries and the heating sheets.

As a preferred portable hand warmer having a magnetic attraction function of the present invention, heating sheet fixing feet are provided on the arc-shaped heat-conducting hardware shells. The face shells are provided with heating sheet fixing holes. The heating sheet fixing feet are mounted in the heating sheet fixing holes to fix the arc-shaped heat-conducting hardware shells.

As a preferred portable hand warmer having a magnetic attraction function of the present invention, snap-fit members are mounted on inner walls of the face shells. the inner walls of the bottom shells are provided with snap-fit holes. The snap-fit members are mounted inside the snap-fit holes to fix the face shells.

As a preferred portable hand warmer having a magnetic attraction function of the present invention, the face shells are provided with heating sheet fixing recesses for accommodating the heating sheets and the arc-shaped heat-conducting hardware shells.

As a preferred portable hand warmer having a magnetic attraction function of the present invention, left and right sides of top portions of the face shells are provided with lanyard holes.

As a preferred portable hand warmer having a magnetic attraction function of the present invention, PCBA board fixing seats are provided in the inner cavities of the bottom shells. The PCBA boards are mounted on the PCBA board fixing seats.

As a preferred portable hand warmer having a magnetic attraction function of the present invention, type-c charging interfaces are mounted on the PCBA boards. Bottom portions of the type-c charging interfaces penetrate through bottom portions of the face shells. Switches and light-emitting members are respectively mounted on the PCBA boards. Buttons are mounted on the switches. The buttons and the light-emitting members penetrate through the face shells.

Compared with the prior art, the present invention has the following beneficial effects:
1. In the present invention, front ends of the face shells are provided with the heating sheet fixing recesses, and the heating sheets are mounted inside the heating sheet fixing recesses, such that heat can be concentrated and quickly transferred to the arc-shaped heat-conducting hardware shells, and then evenly distributed. Such design helps to improve the conduction efficiency of heat energy, allowing a user to feel warmth more quickly when holding the hand warmer, and heat to be distributed more evenly, thereby improving the comfort of use. The heating sheets are placed inside, and are isolated by the arc-shaped heat-conducting hardware shells, such that the user can be effectively prevented from making direct contact with the heating sheets, thereby reducing the risk of burns. In addition to having good heat conductivity, the arc-shaped heat-conducting hardware shells can further provide physical protection for the heating sheets, thereby preventing damage to the heating sheets due to bumps or pressing in daily use, and extending the service life of the hand warmer. By means of a combined use of the heating sheet fixing feet and the heating sheet fixing holes, the arc-shaped heat-conducting hardware shells can be easily disassembled and mounted, which not only facilitates the user's daily cleaning and maintenance, but also means that the heating sheets can be replaced or repaired in a simpler and quicker manner when necessary.
2. In the present invention, the insides of the bottom shells are provided with the magnet positioning cavities, such that the mounting of the magnets can be facilitated, and the hand warmer is caused to have a magnetic attraction function. The magnetic function allows the hand warmer to be easily attracted to the surface of any iron or iron-containing material, thereby increasing the flexibility and convenience of use.

### BRIEF DESCRIPTION OF DRAWINGS

FIG. 1 is a front isometric view of the present invention;

FIG. 2 is a front exploded view of the present invention;

FIG. 3 is a front isometric view of a PCBA board of the present invention;

FIG. 4 is a rear isometric view of a PCBA board of the present invention; and

FIG. 5 is a side sectional view of the present invention.

In the drawings: 1. face shell; 2. lanyard hole; 3. bottom shell; 4. light-emitting member; 5. button; 6. arc-shaped heat-conducting hardware shell; 7. type-c charging interface; 8. magnet positioning cavity; 9. magnet; 10. battery; 11. heating sheet fixing recess; 12. heating sheet; 13. heating sheet fixing foot; 14. PCBA board; 15. snap-fit hole; 16. PCBA board fixing seat; 17. snap-fit member; 18. heating sheet fixing hole; and 19. switch.

### DETAILED DESCRIPTION OF THE EMBODIMENTS

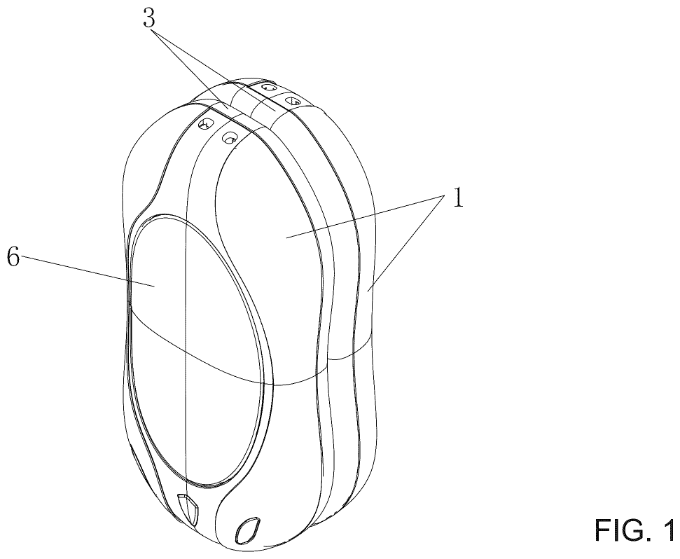

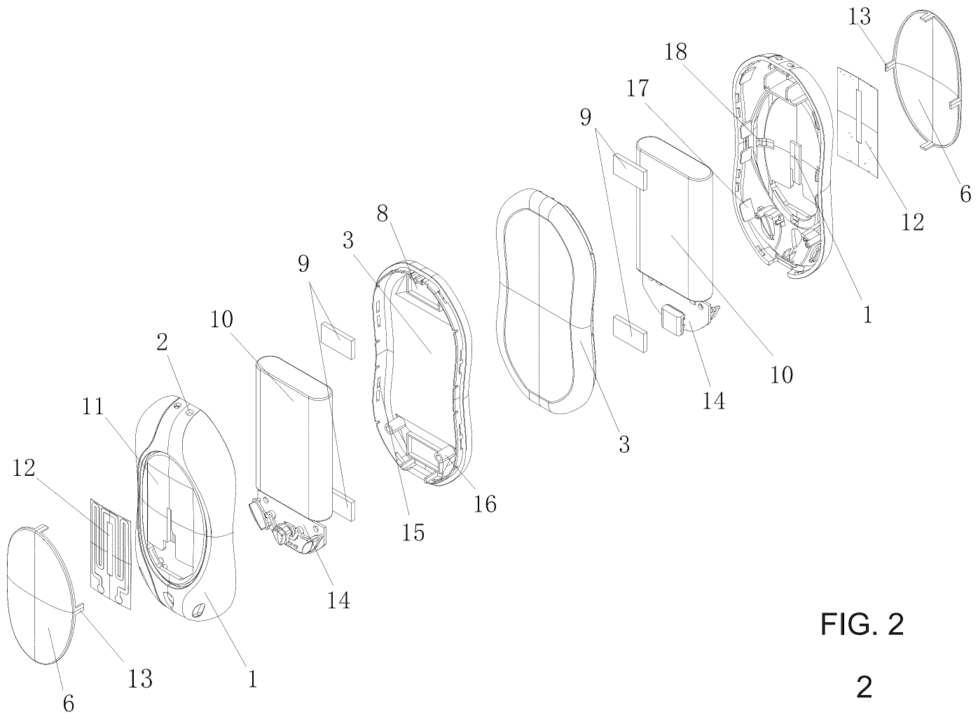

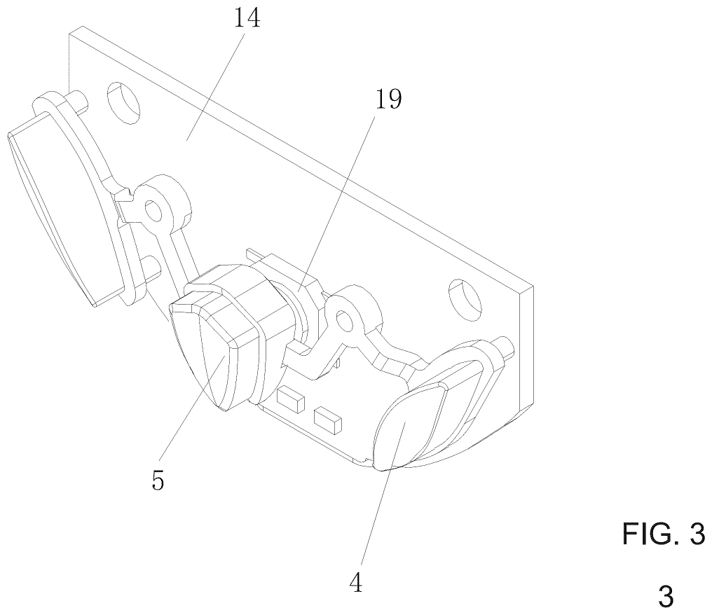

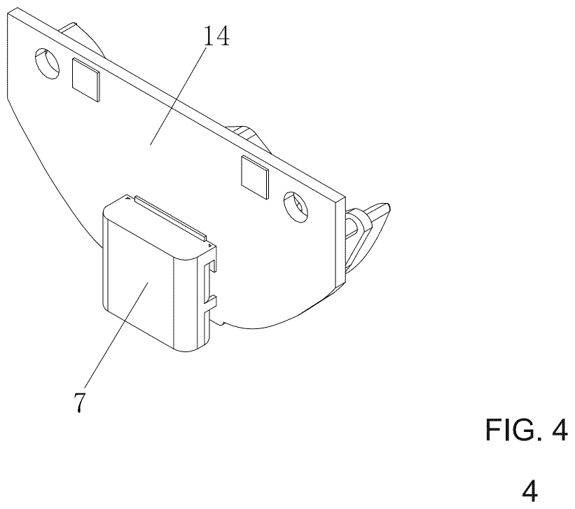

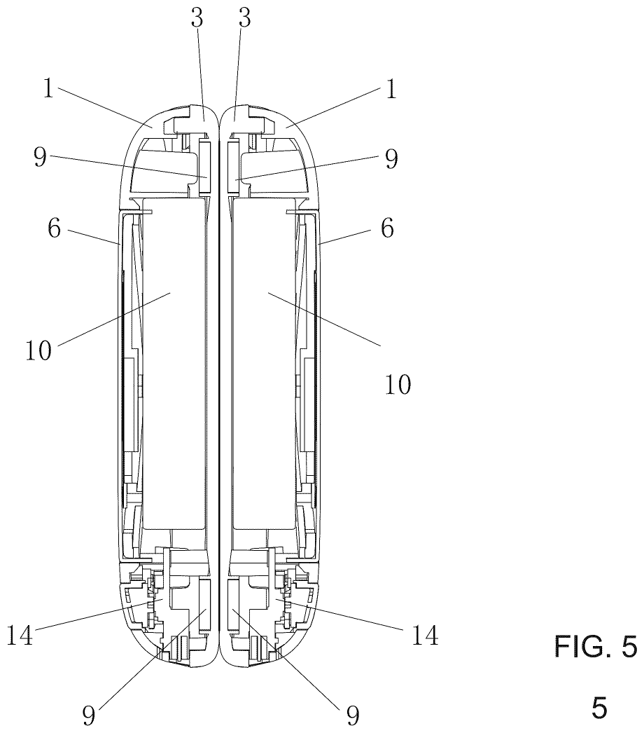

Referring to FIGS. 1-5, a portable hand warmer having a magnetic attraction function comprises two sets of face shells 1 and two sets of bottom shells 3, the face shells 1 being mounted on the bottom shells 3.

Furthermore, snap-fit members 17 are mounted on inner walls of the face shells 1. Inner walls of the bottom shells 3 are provided with snap-fit holes 15. The snap-fit members 17 are mounted inside the snap-fit holes 15 to fix the face shells 1.

A combined use of the snap-fit members 17 and the snap-fit holes 15 can facilitate the mounting and disassembly of the face shells 1, and facilitate a worker to maintain parts inside the face shells 1 and the bottom shells 3.

Furthermore, left and right sides of top portions of the face shells 1 are provided with lanyard holes 2.

The provision of the lanyard holes 2 can facilitate the mounting of a lanyard, and facilitate a user to carry the portable hand warmer.

Furthermore, heating sheets 12 are mounted on the face shells 1. Arc-shaped heat-conducting hardware shells 6 are mounted on the heating sheets 12. The arc-shaped heat-conducting hardware shells 6 are connected to the face shells 1.

Furthermore, heating sheet fixing feet 13 are provided on the arc-shaped heat-conducting hardware shells 6. The face shells 1 are provided with heating sheet fixing holes 18. The heating sheet fixing feet 13 are mounted in the heating sheet fixing holes 18 to fix the arc-shaped heat-conducting hardware shells 6.

Furthermore, the face shells 1 are provided with heating sheet fixing recesses 11 for accommodating the heating sheets 12 and the arc-shaped heat-conducting hardware shells 6.

Front ends of the face shells 1 are provided with the heating sheet fixing recesses 11, and the heating sheets 12 are mounted inside the heating sheet fixing recesses 11, such that heat can be concentrated and quickly transferred to the arc-shaped heat-conducting hardware shells 6, and then evenly distributed. Such design helps to improve the conduction efficiency of heat energy, allowing the user to feel warmth more quickly when holding the hand warmer, and heat to be distributed more evenly, thereby improving the comfort of use. The heating sheets 12 are placed inside, and are isolated by the arc-shaped heat-conducting hardware shells 6, such that the user can be effectively prevented from making direct contact with the heating sheets 12, thereby reducing the risk of burns. In addition to having good heat conductivity, the arc-shaped heat-conducting hardware shells 6 can further provide physical protection for the heating sheets 12, thereby preventing damage to the heating sheets 12 due to bumps or pressing in daily use, and extending the service life of the hand warmer. By means of a combined use of the heating sheet fixing feet 13 and the heating sheet fixing holes 18, the arc-shaped heat-conducting hardware shells 6 can be easily disassembled and mounted, which not only facilitates the user's daily cleaning and maintenance, but also means that the heating sheets 12 can be replaced or repaired in a simpler and quicker manner when necessary.

Furthermore, top portions and bottom portions of the inner walls of the bottom shells 3 are provided with magnet positioning cavities 8. Magnets 9 are mounted inside the magnet positioning cavities 8.

The insides of the bottom shells 3 are provided with the magnet positioning cavities 8, such that the mounting of the magnets 9 can be facilitated, and the hand warmer is caused to have a magnetic attraction function. The magnetic function allows the hand warmer to be easily attracted to the surface of any iron or iron-containing material, thereby increasing the flexibility and convenience of use.

Furthermore, batteries 10 are mounted at middle ends of inner cavities of the bottom shells 3. PCBA boards 14 are mounted at head portions of the inner cavities of the bottom shells 3. The PCBA boards 14 are electrically connected to the batteries 10 and the heating sheets 12.

Furthermore, PCBA board fixing seats 16 are provided in the inner cavities of the bottom shells 3, and the PCBA boards 14 are mounted on the PCBA board fixing seats 16.

The PCBA board fixing seats 16 support and fix the PCBA boards 14 to prevent the PCBA boards 14 from shaking during operation.

Furthermore, type-c charging interfaces 7 are mounted on the PCBA boards 14. Bottom portions of the type-c charging interfaces 7 penetrate through bottom portions of the face shells 1. Switches 19 and light-emitting members 4 are respectively mounted on the PCBA boards 14. Buttons 5 are mounted on the switches 19. The buttons 5 and the light-emitting members 4 penetrate through the face shells 1.

The batteries 10 supply power to electrical devices. When the batteries 10 require charging, the type-c charging interfaces 7 are connected to an external charger to charge the batteries 10 by means of the PCBA boards 14.

The user can press the switches 19 by means of the buttons 5. The switches 19 can transmit control signals to the PCBA boards 14. The PCBA boards 14 control the heating sheets 12 according to the signals. When the heating sheets 12 are operating, the light-emitting members 4 emit light to remind the user.

Furthermore, thermistors are mounted on the heating sheets 12 to measure the operating temperature of the heating sheets 12 and prevent the heating sheets 12 from overheating.

When the heating sheets 12 start to emit heat, resistance values of the thermistors decrease as the temperature rises, which will result in a change in a voltage output by a voltage divider circuit. An operational amplifier monitors this voltage change and compares the voltage with a preset reference voltage. When the temperature measured by the thermistors reaches a set value, an output of the operational amplifier will change, and a power transistor is further controlled to reduce or cut off a current flowing to the heating sheets 12, thereby slowing down or stopping the heating process. As the temperature decreases, the resistance values of the thermistors increase, the circuit starts the heating process again to form a closed-loop feedback control, so as to keep the temperature within a target range.

The embodiments above are only the preferred embodiments of the present invention, and are not intended to limit the present invention. Any modifications, equivalent substitutions, improvements and the like, which are made within the spirit and principles of the present invention, should be included in the protection scope of the present invention.

1. A portable hand warmer having a magnetic attraction function, comprising two sets of face shells and two sets of bottom shells, the face shells being mounted on the bottom shells,
wherein heating sheets are mounted on a front side and a rear side of the face shells, arc-shaped heat-conducting hardware shells are mounted on the heating sheets, and the arc-shaped heat-conducting hardware shells are connected to the face shells;
top portions and bottom portions of inner walls of the bottom shells are provided with magnet positioning cavities, and magnets are mounted inside the magnet positioning cavities, so that the portable hand warmer is capable of being attracted to a surface of any iron or iron-containing material; and
batteries are mounted at middle ends of inner cavities of the bottom shells, PCBA boards are mounted at head portions of the inner cavities of the bottom shells, and the PCBA boards are electrically connected to the batteries and the heating sheets.

2. The portable hand warmer having a magnetic attraction function according to claim 1, wherein heating sheet fixing feet are provided on the arc-shaped heat-conducting hardware shells, the face shells are provided with heating sheet fixing holes, and the heating sheet fixing feet are mounted in the heating sheet fixing holes to fix the arc-shaped heat-conducting hardware shells.

3. The portable hand warmer having a magnetic attraction function according to claim 1, wherein snap-fit members are mounted on inner walls of the face shells, the inner walls of the bottom shells are provided with snap-fit holes, and the snap-fit members are mounted inside the snap-fit holes to fix the face shells.

4. The portable hand warmer having a magnetic attraction function according to claim 1, wherein the face shells are provided with heating sheet fixing recesses for accommodating the heating sheets and the arc-shaped heat-conducting hardware shells.

5. The portable hand warmer having a magnetic attraction function according to claim 1, wherein left and right sides of top portions of the face shells are provided with lanyard holes.

6. The portable hand warmer having a magnetic attraction function according to claim 1, wherein PCBA board fixing seats are provided in the inner cavities of the bottom shells, and the PCBA boards are mounted on the PCBA board fixing seats.

7. The portable hand warmer having a magnetic attraction function according to claim 1, wherein type-c charging interfaces are mounted on the PCBA boards, bottom portions of the type-c charging interfaces penetrate to bottom portions of the face shells, switches and light-emitting members are respectively mounted on the PCBA boards, buttons are mounted on the switches, and the buttons and the light-emitting members penetrate to the face shells.
